(19) United States
(12) Patent Application Publication
(10) Pub. No.: US 2022/0141937 A1
(43) Pub. Date: May 5, 2022

(54) Illuminating Television Mounting Device

(71) Applicant: Derek Vanhoose, Charlotte, NC (US)

(72) Inventor: Derek Vanhoose, Charlotte, NC (US)

(21) Appl. No.: 17/514,799

(22) Filed: Oct. 29, 2021

Related U.S. Application Data
(60) Provisional application No. 63/107,007, filed on Oct. 29, 2020.

(51) Int. Cl. H05B 47/11; F16M 13/02; F16M 11/04; H05B 47/19

(52) U.S. Cl. CPC H05B 47/11; H05B 47/19; F16M 11/043; F16M 13/02

(57) ABSTRACT

An illuminating television mounting device is provided. The illuminating television mounting device includes a base frame. The base frame is designed to be secured to a vertical surface. A bracket is attached to the base frame. The bracket is designed to receive a television on a front surface of the bracket. A number of lights are placed on the bracket. The lights are connected to a control center. The control center is designed to control the plurality of lights. The control center includes at least one input port.

### CROSS REFERENCE TO RELATED APPLICATIONS

This application claims the benefit of U.S. Provisional Application No. 63/107,007 filed on Oct. 29, 2020. The above identified patent application is herein incorporated by reference in its entirety to provide continuity of disclosure.

### BACKGROUND OF THE INVENTION

The present invention relates to an illuminating television mounting device. More specifically, the present invention provides a television bracket configured to provide ambient backlighting to a mounted television.

With advances to the average at-home media viewing experience, people are looking for additional ways to create ambient environments in their homes to enhance their time watching television programs and movies. Spending a long period of time in front of a television watching a movie or binge-watching a television show can cause eye strain, eye fatigue, and blurry vision. Ambient light has been proven to reduce stress on the eye when coupled with watching television. In addition, ambient lights, when in sync with the video signal, produce an enhanced home theater or gaming experience.

Installing ambient lighting around a television can be a time-consuming and frustrating process. As flat-screen televisions have become more and more popular, more and more users have begun mounting their televisions on walls, as opposed to placing them on a television stand. Some of these wall mounts do permit the user to manipulate the position of the television, however, not all of them do.

Users may desire additional ambient lighting for the bracket. For the people who do want additional lighting, the standard methods of installing lights near a television can lead to cord clutter as well as difficulty in adjusting the position of the television. Additionally, the standard methods of installing lights do not have a feature that allows the emitted light to correspond with the screen via a video signal. When the television screen is strongly displaying a color, the ambient light can complement the screen to make for a better viewing experience. In order to address these concerns, the present invention provides a television wall mount with controllable integrated lighting that will reduce the stress on the eyes of the viewer and remove the hassle of installing ambient light and allow for video signal control of the lights.

### SUMMARY OF THE INVENTION

In view of the foregoing disadvantages inherent in the known types of television mounts and backlighting systems now present in the prior art, the present invention provides an illuminating television mounting device wherein the same can be utilized for providing convenience for the user when providing a manipulable television mount with integrated ambient lighting.

The present system comprises a base frame. The base frame is securable to a wall or other vertical surface. A bracket is affixed to the front surface of the base frame. The bracket is configured to receive a television on a front surface of the base frame. A plurality of lights is disposed on the bracket. The plurality of lights is in operable connection with a control circuit. The control circuit comprises one or more input ports.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a rear view of an embodiment of the illuminating television mounting device.

FIG. 2 shows a close-up view of a control circuit of an embodiment of the illuminating television mounting device.

FIG. 3 shows a front demonstrative view of an embodiment of the illuminating television mounting device.

### DETAILED DESCRIPTION OF THE INVENTION

Reference is made herein to the attached drawings. Like reference numerals are used throughout the drawings to depict like or similar elements of the illuminating television mounting device. The figures are intended for representative purposes only and should not be considered to be limiting in any respect.

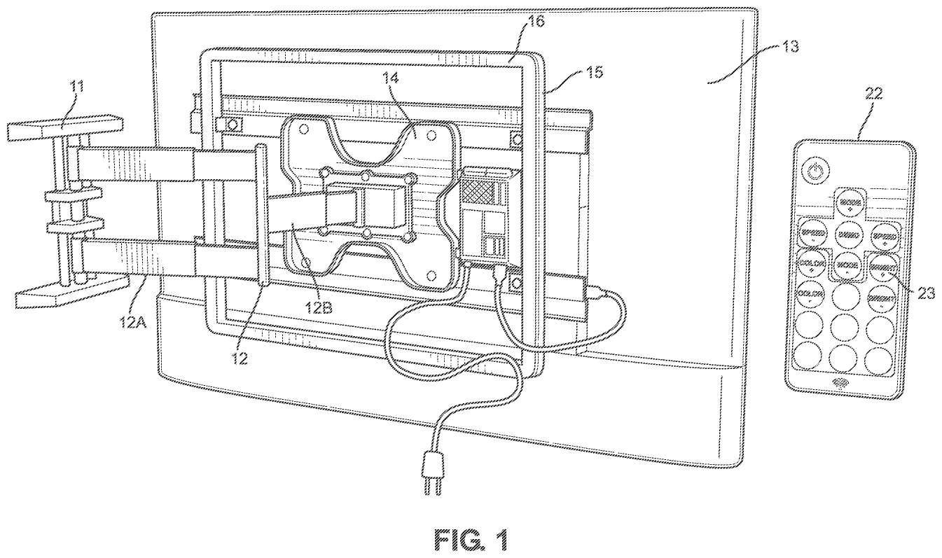

Referring now to FIG. 1, there is shown a rear view of an embodiment of the illuminating television mounting device. The illuminating television mounting device 10 comprises a base frame 11. The base frame 11 is configured to be secured to a vertical surface, such as a wall or a post. Specifically, the base frame 11 provides a substantially flat interface which will rest flush, or substantially flush with the wail or the other vertical surface. One or more fasteners, such as anchors or screws, may be utilized to secure the base frame 11 to the vertical surface.

In the illustrated embodiment, the base frame 11 comprises an extension arm 12. The extension arm 12 comprises one or more rigid support arms 12a, 12b hingedly affixed to the base frame 11 and to each other. Furthermore, in some embodiments, one or more support arms 12a, 12b may be telescopic. The extension arm 12 is configured to enable the user to adjust the distance at which the television 13 extends from the wall, as well as the horizontal positioning of the television 13.

A bracket 14 is affixed to the front face of the base frame 11. The bracket 14 is configured to receive a television 13 on a front surface thereof. By securing the television 13 to the bracket 14, the television 13 may be secured in a vertically elevated manner, improving the viewing experience of the user. The bracket 14 may be rotatably secured to the base frame 11, such that the angle the television is presented may be manipulated by the user. In the illustrated embodiment, the television 13 is secured to the bracket 14 via a plurality of fasteners extending through apertures of the bracket 14 into the television 13. However, in alternate embodiments, the television 13 may be secured to the bracket 14 by any known means.

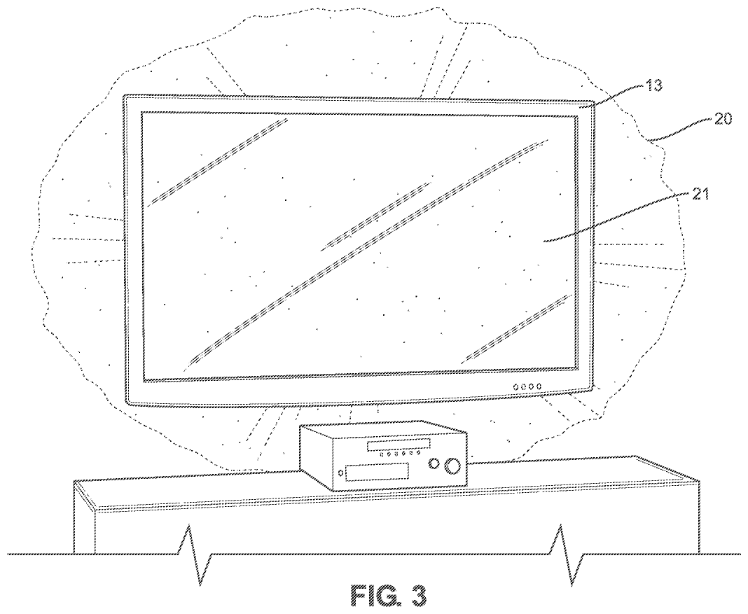

A plurality of lights 15 are disposed on the bracket 14. The plurality of lights 15 are configured to provide backlighting to the television 13 installed upon the illuminating television mounting device 10 by shining light upon the vertical surface on which the illuminating television mounting device 10 is installed (as shown in FIG. 3). In one embodiment, the plurality of lights comprises a plurality of light electric diodes (LEDs). In the illustrated embodiment, the plurality of lights 15 are installed along a side surface of the bracket 14, such that the lights are shown outwardly from the side of the bracket to define a wider area of light from the illuminating television mounting device 10. Specifically, the plurality of lights 15 is disposed entirely around the perimeter of a light frame 16 defined on the bracket 14.

In the illustrated embodiment, a remote control 22 may be utilized to control the plurality of lights 15. The remote control 22 comprises a plurality of buttons 23. The plurality of buttons 23 are configured to control the various aspects of the ambient lighting produced by the plurality of lights 15. For example, the remote control 22 may be utilized to change the color, brightness, saturation, contrast or any other aspect of the plurality of lights 15. Furthermore, the remote control 22 may be utilized to control the mode of the plurality of lights 15, such as if the plurality of lights 15 will remain in a fixed color or a variable color (as shown and discussed in FIG. 3).

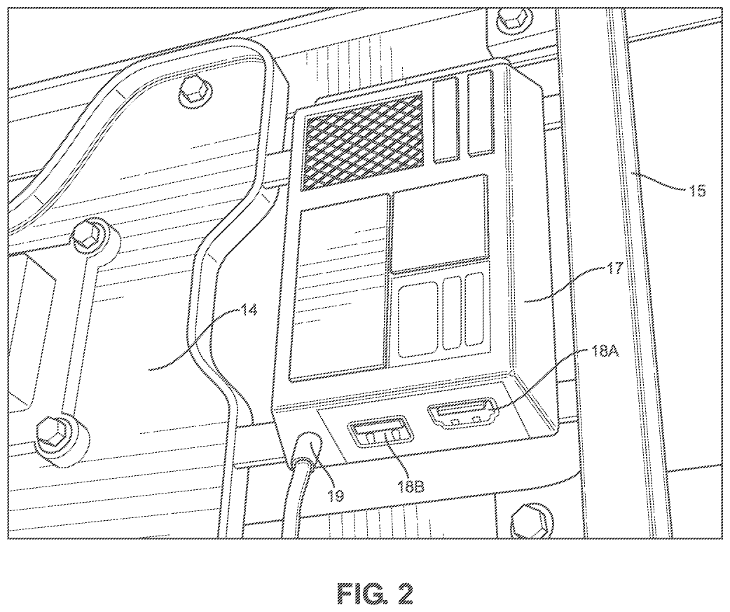

Referring now to FIG. 2, there is shown a close-up view of a control circuit of an embodiment of the illuminating television mounting device. The plurality of lights 15 are in operable connection with a control circuit 17. In the illustrated embodiment, the control circuit 17 is contained within an electronic housing disposed on the bracket 14. The control circuit 17 is configured to control the plurality of lights 15. Specifically, the control circuit may be configured to activate and deactivate each light of the plurality of lights 15, as well as change the color and the brightness of each of the plurality of lights 15.

The control center 17 comprises a wireless transceiver. The wireless transceiver is configured to enable the user to control the plurality of lights 15 using a wireless device. For example, the user can transmit instructions to the control center 17 via a remote control (shown in FIG. 1) or by a mobile device with a paired application installed thereon. The user may be able to adjust the color, brightness, or other characteristics of the plurality of lights 15. The user may also be able to turn the plurality of lights 15 on and off using the remote control or the mobile device.

The control center 17 comprises one or more input ports 18a, 18b thereon. In the illustrated embodiment, the control center 17 comprises an HDMI input port 18a and a USB input port 18b. The user may utilize the input ports 18a, 18b to connect the control center 17 to the television or to a peripheral media device, such as a Blu Ray player or a gaming console. By connecting the control center 17 to the television or peripheral media device, the plurality of lights 15 may be controlled as a function of the media being presented thereby. Furthermore, in the demonstrated embodiment, the control center 17 comprises a power connection 19. The power connection 19 may be connected to an external power source, such as an outlet or may run to the television itself, such that power may be provided to the control center 17 via the television power supply.

Referring now to FIG. 3, there is shown a front demonstrative view of an embodiment of the illuminating television mounting device. In the illustrated embodiment, the control circuit is configured to provide ambient lighting 20 in response to a video feed received by the control circuit. Specifically, the control circuit comprises a processor configured to analyse a video signal, such as a video signal from the television or a peripheral media device, and to determine one or more colors and/or brightness levels to output via the plurality of lights. For example, if the onscreen image 21 of the television 13 corresponds to a blue color, the control center may change the color of the plurality of lights to emit a blue color in ambient lighting 20. As such, the viewing experience of the user can be enhanced through the use of ambient lighting that is tied to the media being presented on the television 13.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminating television mounting device, comprising:
a base frame;
the base frame securable to a wall;
a bracket affixed to a front surface of the base frame;
the bracket configured to receive a television on a front surface thereof;
a plurality of lights disposed on the bracket;
the plurality of lights in operable connection with a control circuit;
the control circuit comprising one or more input ports.

2) The illuminating television mounting device of claim 1, wherein the base frame is securable to the wall via a fastener.

3) The illuminating television mounting device of claim 1, wherein the base frame comprises an extension arm.

4) The illuminating television mounting device of claim 1, wherein the bracket is rotatably affixed to the base frame.

5) The illuminating television mounting device of claim 1, wherein the bracket comprises one or more apertures disposed therethrough.

6) The illuminating television mounting device of claim 1, wherein the plurality of lights comprises a plurality of light electric diodes.

7) The illuminating television mounting device of claim 1, wherein the plurality of lights is disposed on an outside surface of the bracket.

8) The illuminating television mounting device of claim 1, wherein the plurality of lights is disposed entirely around the perimeter of a light frame defined on the bracket.

9) The illuminating television mounting device of claim 1, wherein the control circuit is disposed within an electronic housing on the bracket.

10) The illuminating television mounting device of claim 1, wherein control circuit comprises a wireless transceiver.

11) The illuminating television mounting device of claim 1, wherein a remote control is in operable connection with the control circuit via the wireless transceiver.

12) The illuminating television mounting device of claim 1, wherein a mobile device is in operable connection with the control circuit via the wireless transceiver.

13) The illuminating television mounting device of claim 1, wherein the control circuit comprises an HDMI input port.

14) The illuminating television mounting device of claim 1, wherein the control circuit comprises a USB input port.

15) The illuminating television mounting device of claim 1, wherein the control circuit is programmed to provide ambient lighting in response to a video feed received by the control circuit.
